(19) United States
(12) Patent Application Publication
(10) Pub. No.: US 2025/0037180 A1
(43) Pub. Date: Jan. 30, 2025

(54) ADAPTIVE PROMPTING

(71) Applicant: INTERNATIONAL BUSINESS MACHINES CORPORATION, Armonk, NY (US)

(72) Inventors: Logan BAILEY, Atlanta, GA (US); Zachary A. SILVERSTEIN, Georgetown, TX (US); Jeremy R. FOX, Georgetown, TX (US); Melanie DAUBER, Oceanside, NY (US); Jacob Ryan JEPPERSON, St. Paul, MN (US)

(21) Appl. No.: 18/360,155

(22) Filed: Jul. 27, 2023

(51) Int. Cl. G06Q 30/0601; G06F 40/40; G06Q 30/0282

(52) U.S. Cl. CPC G06Q 30/0627; G06F 40/40; G06Q 30/0282; G06Q 30/0643

(57) ABSTRACT

Methods, computer program products, and systems are presented. The method computer program products, and systems can include, for instance: determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

### BACKGROUND

Embodiments herein relate generally to computer user interfaces, and particularly to user interfaces for adaptively presenting prompting data.

Data structures have been employed for improving operation of computer system. A data structure refers to an organization of data in a computer environment for improved computer system operation. Data structure types include containers, lists, stacks, queues, tables and graphs. Data structures have been employed for improved computer system operation, e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

In another aspect, a computer program product can be provided. The computer program product can include a computer readable storage medium readable by one or more processing circuit and storing instructions for execution by one or more processor for performing a method. The method can include, for example: determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

In a further aspect, a system can be provided. The system can include, for example a memory. In addition, the system can include one or more processor in communication with the memory. Further, the system can include program instructions executable by the one or more processor via the memory to perform a method. The method can include, for example: determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, user equipment devices, IoT devices, enterprise systems, and a social media system according to one embodiment;

FIG. 2A-2B is a flowchart depicting a method for performance by a manager system interoperating with UE devices, IoT devices, enterprise systems, and a social media system according to one embodiment;

FIG. 3 depicts a user interface with adaptively presented prompting data, according to one embodiment;

FIG. 4 depicts a map of a functional space associated to user;

FIG. 5 depicts clustering analysis for use in ranking candidate articles, according to one embodiment;

FIG. 6 depicts the user interface that presents adaptively presented prompting data, according to one embodiment;

FIG. 7 depicts a machine learning for predicting the complementary article for acquisition, according to one embodiment;

FIG. 8 depicts clustering analysis for use in clustering like users, according to one embodiment;

FIG. 9 depicts a map for a functional space of the user, according to one embodiment;

FIG. 10 depicts a computing environment, according to one embodiment.

### DETAILED DESCRIPTION

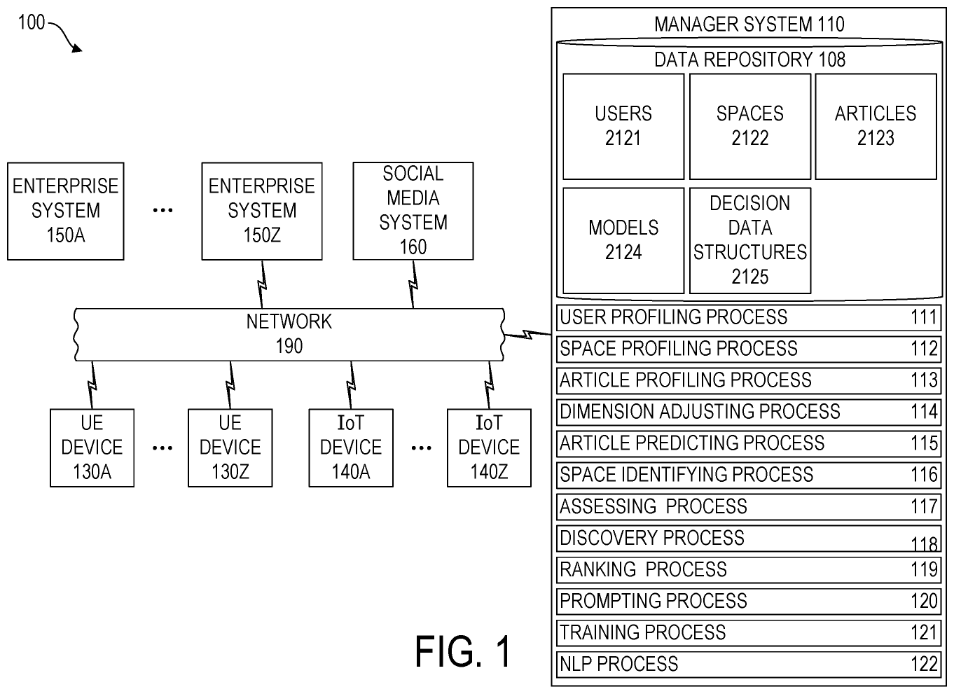

System 100 for use in prompting acquisition of articles is shown in FIG. 1. System 100 can include manager system 110 having an associated data repository 108, a plurality of user equipment (UE) devices 130A-130Z, IoT devices 140-140Z, enterprise systems 150A-150Z, and one or more social media system 160. Manager system 110, UE devices 130A-130Z, IoT devices 140A-140Z, enterprise systems 150A-150Z, and one or more social media system 160 can be in communication with one another via network 190. Network 190 can include, e.g., a physical network and/or a virtual network. A physical network can include, for example, a physical telecommunications network connecting numerous computing nodes or systems such as computer servers and computer clients. A virtual network can include, for example, a combination of numerous physical networks or parts thereof into a logical virtual network. In another example, numerous virtual networks can be defined over a single physical network. In reference to UE devices 130A-130Z, IoT devices 140A-140Z, enterprise systems 150A-150Z, “Z” can refer to an integer of any arbitrary value, e.g., there can be tens to thousands, to millions of instances of each of UE devices 130A-130Z, IoT devices 140A-140Z, and enterprise systems 150A-150Z.

In one embodiment, manager system 110 can be external to each of UE devices 130A-130Z, IoT devices 140A-140Z, and enterprise systems 150A-150Z. In another embodiment, manager system 110 can be collocated with one or more instance of IoT devices 130A-130Z, IoT devices 140A-140Z, and/or enterprise systems 150A-150Z. In one example, an enterprise system of enterprise systems 150A-150Z can host served webpages that define webpage based user interfaces that are accessed by various ones of UE devices 130A-130Z. In one scenario, manager system 110 can be operated by a service provider providing services to end users as well as support services to article providers. In one scenario, manager system 110 can be operated by an article provider that serves user interface defining webpages to end users. In the latter scenario, manager system 110 may be more likely to be collocated with an enterprise system.

In one example, manager system 110 can include one or more computing node. In one example, each UE device of UE devices 130A-130Z can include one or more computing node. In one example, each IoT device of IoT devices 140A-140Z can include one or more computing node. In one example, each enterprise system of enterprise systems 150A-150Z can include one or more computing node. In one example, one or more social media system 160 can include one or more computing node.

In one example, respective ones of UE devices 130A-130Z can be computing node-based devices provided, e.g., by a client computer, such as a mobile device, e.g., a smart phone or tablet, a laptop, or PC that runs one or more program. The one or more program can include a web browser for browsing webpages in one example. IoT devices 140A-140Z can be disposed, e.g., permanently or temporarily at locations of functional spaces associated to users of system 100.

In one example, an IoT device of IoT devices 140A-140Z can be provided by a residential robot, e.g., an automated vacuum cleaner with one or more sensor for tracking a location of the IoT device over time. In another example, an IoT device of IoT devices 140A-140Z can be provided by a camera-equipped device. In another example, an IoT device of IoT devices 140A-140Z can include multiple sensors, e.g., for location tracking and image capturing.

Social media system 160 can include a collection of files, including for example, HTML files, CSS files, image files, and JavaScript files. Social media system 160 can be a social website such as FACEBOOK® (Facebook is a registered trademark of Facebook, Inc.), TWITTER® (Twitter is a registered trademark of Twitter, Inc.), LINKEDIN® (LinkedIn is a registered trademark of LinkedIn Corporation), or INSTAGRAM® (Instagram is a registered trademark of Instagram, LLC). Computer implemented social networks incorporate messaging systems that are capable of receiving and transmitting messages to client computers of participant users of the messaging systems. Messaging systems can also be incorporated in systems that have minimal or no social network attributes. A messaging system can be provided by a short message system (SMS) text message delivery service of a mobile phone cellular network provider, or an email delivery system. Manager system 110 can include a messaging system in one embodiment. During a process of registration wherein a user of system 100 registers as a registered user of system 100, a user sending registration data can send with permission data defining the registration data a permission that grants access by manager system 110 to data of the user within social media system 160. On being registered, manager system 110 can examine data of social media system 160 e.g., to determine whether first and second users are in communication with one another via a messaging system of social media system 160. A user can enter registration data using a user interface displayed on a UE device of UE devices 130A-130Z. Entered registration data can include, e.g., name, address, social media account information, other contact information, biographical information, background information, preferences information, and/or permissions data, e.g., can include permissions data allowing manager system 110 to query data of a social media account of a user provided by social media system 160 including messaging system data and any other data of the user. When a user opts-in to register into system 100 and grants system 100 permission to access data of social media system 160, system 100 can inform the user as to what data is collected and why, that any collected personal data may be encrypted, that the user can opt out at any time, and that if the user opts out, any personal data of the user is deleted.

Data repository 108 can store various data. In users area 2121, data repository 108 can store data on users of system 100. User data within users area 2121 can include, e.g., a universally unique identifier (UUID) assigned by manager system 110 to respective users when the respective users register with manager system 110. User data within users area 2121 can also include data on preferences of users and article acquisition history of users. In users area 2121, permissions data of various users can be recorded. Permissions data can include permissions that permit manager system 110 to use, e.g., browser data, social media data, UE device data, article acquisition history, and/or IoT device data of the various users.

In spaces area 2122, data repository 108 can store data on functional spaces associated to various users. Embodiments herein recognize that respective users of system 100 can include associated functional spaces. e.g., functional spaces of a residence or office of a user, functional spaces of an operations venue. In one example, a residence of a user can be divided, e.g., into a kitchen functional space, a home gym functional space, a living room functional space, a garage functional space, a home office functional space, and so on. Embodiments herein can be configured to track and profile functional spaces associated to users of system 100. In one example, a user herein can be an agent user of an enterprise and a functional space can include a functional space operated by the enterprise. In one example, a functional space can be provided by a data center.

Data repository 108 in articles area 2123 can store data on articles for acquisition by users. Articles for acquisition by users can include, e.g., articles for use in functional spaces associated to users, e.g., kitchen articles for use in kitchen functional spaces, home gym articles for use in home gyms associated to users, office articles for use in office functional spaces associated to users, operations articles for use in operations facilities functional spaces, and so on.

Data repository 108 and models area 2124 can store trained predictive models that are trained by machine learning processes performed by manager system 110. Predictive models stored in models area 2124 can include, e.g., trained predictive models for predicting articles that are complementary to an article that is selected for acquisition by a user.

Data repository 108 in decision data structures area 2125 can store decision data structures for use in return of action decisions by manager system 110. Decision data structures stored in decision data structures area 2125 can include, e.g., decision tables, decision trees, lists, and the like.

Manager system 110 can run various processes. Manager system 110 running user profiling process 111 can include manager system 110 iteratively querying various data sources for user data in order to update a user profile for various users of system 100. A user profile data of a user can include data, e.g., on preferences of users and article acquisition behavior of users. Data sources that can be queried by manager system 110 in updating a user profile can include, e.g., UE devices 130A-130Z associated to respective users of system 100 and one or more social media system 160 and other data sources.

Manager system 110 running space profiling process 112 can include manager system 110 iteratively updating functional space data associated to respective users of system 100. Manager system 110 running space profiling process 112 can include manager system 110 iteratively updating data attributes associated to various respective functional spaces associated to respective users of system 100. Functional spaces herein can refer to physical functional spaces of the user. Examples can include, e.g., rooms of a home or office or operations venue associated to a user. Manager system 110 running space profiling process 112 can include manager system 110 iteratively querying data from IoT devices of IoT devices 140A-140Z. In one example, one or more robot defining an IoT device can be disposed in respective residences of respective users of system 100, or other functional spaces, e.g., of offices or operations venues including operations facilities. These IoT devices can include respective sensors that iteratively capture image data or other sensor-based representations of functional spaces associated to various users of system 100.

Manager system 110 running space profiling process 112 can include manager system 110 running image recognition process to examine spatial image data representing a feature of interest and can include manager system 110 employing pattern recognition processing using one or more of, e.g., feature extraction algorithms, classification algorithms, and/or clustering algorithms. In one embodiment, manager system 110 running an image recognition process can include performing of digital image processing. Digital image processing can include, e.g., filtering, edge detection, shape classification, optical character recognition (OCR), and/or encoded information decoding.

Manager system 110 running space profiling process 112 can record text based tags associated to the various functional spaces of a user that describe the space. The text based tags can include text based tags that describe articles that are commonly found in such functional spaces. For example, a functional space having the classification of “home office” can include such descriptive text based tags as desk, office chair, laptop, computer, filing cabinet, printer, paperclip, folder, or papers.

Manager system 110 running article profiling process 113 can include manager system 110 iteratively querying various data sources, e.g., UE devices 130A-130Z and IoT devices 140A-140Z. In one embodiment, UE devices of UE devices 130A-130Z can include, e.g., respective cameras and/or other sensors that can iteratively capture image data or other space representing data representing a functional space and/or an article associated to user. Manager system 110 running article profiling process 113 can include manager system 110 iteratively querying various data sources for data respecting various articles that can be acquired by various users of system 100. Manager system 110 can include manager system 110 iteratively querying enterprise systems of article providers, e.g., providers of kitchen functional space articles, home gym functional space articles, home office functional space articles, operations venues, and the like. In one use case, an enterprise system queried by manager system 110 can include a hosted website of a user that presents portals for acquisition of articles. Manager system 110 running an article profiling process can build up data respecting dimensions of articles, e.g., by processing manuals and photographs regarding various articles. Manager system 110 can build up dimensional data regarding articles from instruction manuals, specification sheets, lists, boilerplate data, and the like. Manager system 110 running article profiling process 113 can include manager system 110 running an image recognition process to examine spatial image data representing a feature of interest. Manager system 110 running such image recognition process can include manager system 110 employing a pattern recognition processing using one or more of, e.g., feature extraction algorithms, classification algorithms, and/or clustering algorithms. In one embodiment, manager system 110 running an image recognition process can include performing of digital image processing. Digital image processing can include, e.g., filtering, edge detection, shape classification, optical character recognition (OCR), and/or encoded information decoding.

Manager system 110 running dimension adjusting process 114 can adjust dimensions on articles based on text based processing of text respecting the various articles. Manager system 110 running dimension adjusting process 114 can include manager system 110 processing text respecting an article using natural language processing and responsively to the performing of natural language processing can adjust dimension information recorded for an article, e.g., increase a recorded dimension of an article for use in performing fitting assessing or decrease a recorded dimension of an article in dependence on the processing of text. In one aspect, manager system 110 running dimension adjusting process 114 can include manager system 110 identifying topics, extracting topics from text indicating that an article is larger than the dimensional information associated to the article or, alternatively, can determine that an article is smaller than is indicated by the dimensional information associated to the article. Manager system 110, in dependence on such text processing, can adjust recorded size for an article in dependence on the text based processing.

Manager system 110 running article predicting process 115 can predict that there is a complementary article associated to an article selected for acquisition. Embodiments herein recognize that users can commonly acquire articles in combination. In one example, a printer can be acquired in combination with a printer stand in such articles, i.e., the printer and the printer stand can be regarded to be complementary articles. In another example, manager system 110 can predict that an office chair will be acquired in combination with an office desk. Other examples of articles that can be revealed as complementary can include, e.g., electric vehicles and electric chargers, tables and lamps, cutting boards and knives, or servers and server racks. Embodiments herein can extract associations between articles and reveal and predict the acquisition of associated complementary articles that are beyond a human's ability to predict without features herein. Embodiments herein recognize that different types of users can exhibit differentiated behaviors in terms of associating complementary articles. In other words, a first type of user may treat a first and second article as complementary, and a second type of user may not.

Manager system 110 running article predicting process 115 can include manager system 110 querying a trained predictive model that has been trained with machine learning training data. In one example, such a predictive model can be trained with iterations of training data wherein the iterations of training data specify historical article acquisitions by a current user and/or a crowd sourced collection of users.

Manager system 110 running space identifying process 116 can identify a functional space of the user that is associated to an article for acquisition. In one embodiment, manager system 110 running space identifying process 116 can monitor user data, e.g., user browser data for an event indicating selection of an article for acquisition. In one example, manager system 110 can flag the placement of an online article for acquisition onto an online shopping cart as the selection of such article for acquisition. In response to determining that an article has been selected for acquisition, manager system 110 can identify a user functional space associated to the article for acquisition. In one example, manager system 110 performing such identifying can compare text based tags associated to functional spaces to text based tags associated to articles, and based on a match, manager system 110 can identify a candidate functional space associated to a user as a space associated to a current article for acquisition. Manager system 110 running article profiling process can require text based tags describing the articles. For example, a toaster can include such tags as “used in kitchen, used for toasting bread, kitchen appliance.” and the like. Manager system 110 running space identifying process 116 can identify a functional space of a user associated to an article for acquisition by the user by determining that there is a threshold satisfying level of text based tags as between the article for acquisition by the user and the functional space of the user.

Manager system 110 running assessing process 117 can assess fitting of an article in a functional space identified for the article. Manager system 110 running assessing process 117 can compare dimensions of an article for acquisition to dimensions of open areas within functional spaces identified for the article for acquisition. Manager system 110 running assessing process 117 can query articles area 2123 for article dimension information as obtained by article profiling process 113 and can query spaces area 2122 for functional space dimension information as obtained by space profiling process 112. On determining that there is an open area within a functional space that can accommodate fitting of an article for acquisition, manager system 110 can qualify an article selected for acquisition for completion of acquisition by a user. Manager system 110 can responsively send positive reinforming prompting data on such qualifying that prompts for acquisition of the article selected for acquisition. Manager system 110 performing assessing process 117 can include manager system 110 determining that there is no open area within a functional space that can accommodate fitting an article for acquisition. In such a circumstance, manager system 110 can trigger various other processes including discovery process 118 for discovering candidate alternative articles that can be accommodated within a functional space identified for an article for acquisition. Manager system 110 running assessing process 117 can assess the ability of a functional space to accommodate fitting an article for acquisition in combination with one or more additional article where manager system 110 running article predicting process 115 has determined that there is one or more complementary article associated to the article for acquisition.

Manager system 110 running discovery process 118 can discover alternative articles for acquisition relative to the article selected for acquisition. Manager system 110 running discovery process 118 can include manager system 110 querying articles area 2123 of data repository 108 for alternative articles.

Manager system 110 running ranking process 119 can rank in order various articles discovered by manager system 110 running discovery process 118.

Manager system 110 running prompting process 120 can include manager system 110 generating and presenting prompting data for prompting a user to take action. Such prompting data, in one example, can include prompting data that reinforces selection of an article determined to be an article selected for acquisition. Such prompting data can include, for example, prompting data that prompts a user to select for acquisition an alternative one or more article that has been determined by manager system 110 running discovery process 118 to be an article for acquisition.

Manager system 110 running training process 121 can include manager system 110 training one or more predictive model. In one example, manager system 110 running training process 121 can include manager system 110 training a predictive model that predicts one or more complementary article that is associated to an article for acquisition.

Manager system 110 can run natural language process (NLP) process 122 to process data for preparation of records that are stored in data repository 108. Manager system 110 can run NLP process 122 for determining one or more NLP output parameter of a message. NLP process 122 can include one or more of a topic classification process that determines topics of messages and outputs one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters, e.g., one of more “social tendency” NLP output parameter, or one or more “writing style” NLP output parameter.

By running of NLP process 122, manager system 110 can perform a number of processes including one or more of (a) topic classification and output of one or more topic NLP output parameter for a received message, (b) sentiment classification and output of one or more sentiment NLP output parameter for a received message, or (c) other NLP classifications and output of one or more other NLP output parameter for the received message.

Topic analysis for topic classification and output of NLP output parameters can include topic segmentation to identify several topics within a message. Topic analysis can apply a variety of technologies, e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust.” “fear,” “joy,” and “sadness.”

Manager system 110 running NLP process 122 can include manager system 110 returning NLP output parameters in addition to those specification topic and sentiment, e.g., can provide sentence segmentation tags, and part of speech tags. Manager system 110 can use sentence segmentation parameters to determine, e.g., that an action topic and an entity topic are referenced in a common sentence, for example.

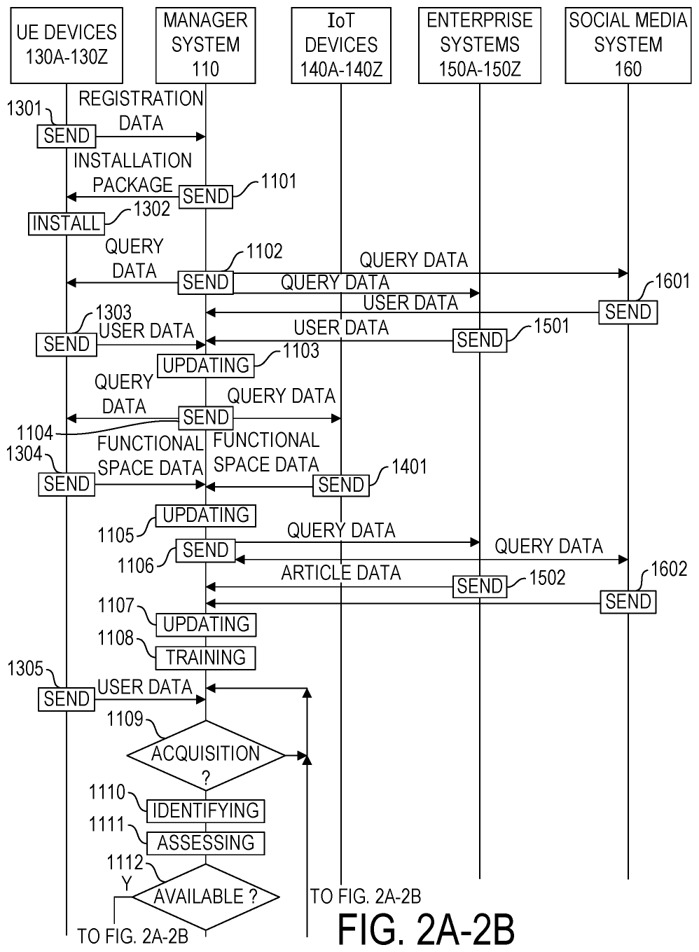

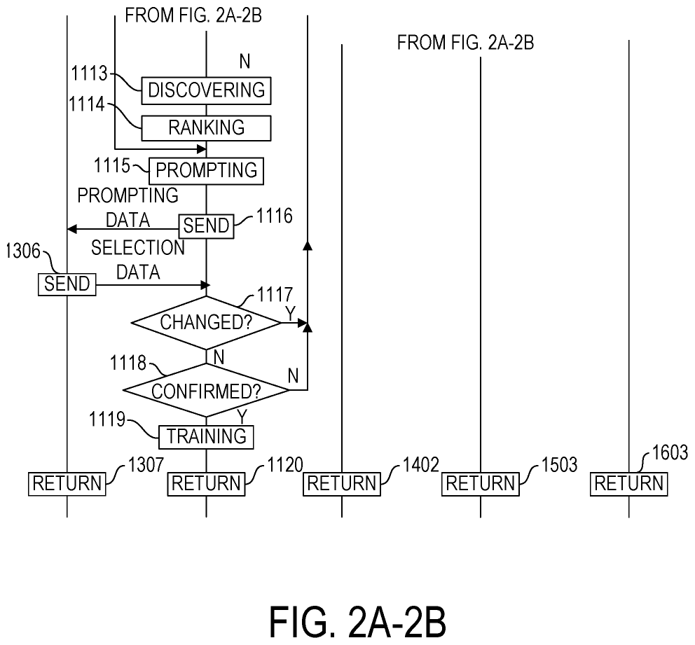

A method for performance by manager system 110 interoperating with UE devices 130A-130Z, IoT devices 140A-140Z, enterprise systems 150A-150C, and one or more social media system 160 is as set forth in reference to the flowchart of FIGS. 2A to 2B.

At block 1301, UE devices 130A-130Z can be sending registration data for receipt by manager system 110. Registration data of users of system 100 can include, e.g., contact information, including social media address information, permissions information, which permits manager system 110 to use personal information of users as permitted by the various users such as social media information, user device information, article acquisition history information, IoT device information, and the like. Registration data can include data that defines preferences of users, e.g., topics of interest to users and sentiments associated to such topics. Registration data can also include, e.g., dimensional information of functional spaces and articles of users, e.g., blueprints, architectural drawings, video data, and the like, that is processable by manager system 110 for extraction of spaces and/or articles data for storage into spaces area 2122 and articles area 2123, respectively.

Manager system 110 on receipt of registration data can send to UE devices 130A-130Z at send block 1101 an installation package for installation on respective ones of UE devices 130A-130Z. An installation package for installation on a UE device herein can include, e.g., libraries and executable code which on installation on a respective UE device can configure the UE device with features for use in system 100.

On receipt of the installation packages sent at block 1101, UE devices 130A-130Z at install block 1302 can install the respective installation packages. Executable code installed at install block 1302 can include, e.g., a browser plug-in that results in browser data of a respective UE device to be routed to manager system 110 for processing by manager system 110. The routed browser data can include browser data processable to discern online article acquisition actions by user, e.g., the placement by user of a selected article for acquisition into a shopping cart or completing checkout of a selected article. Manager system 110 can be configured to ascertain that a user has selected an article for acquisition by examining the browser of the user to determine that the user has placed a selected article in an online shopping cart. With the sending of installation packages for installation on UE devices at block 1101, manager system 110 can be sending installation packages for installation on IoT devices 140A-140Z.

At block 1102, manager system 110 can be sending query data for receipt of user data. At send block 1102, manager system 110 can send query data to UE devices 130A-130Z and can also send query data to social media system 160. In response to the received query data sent at block 1102, UE devices 130A-130Z at send block 1303 can send user data for receipt by manager system 110. In response to the query data sent at block 1102, social media system 160 at send block 1601 can send user data to manager system 110. On receipt of the received user data, manager system 110 at updating block 1103 can perform updating of user profiles for respective users of system 100. The user profiles can specify, e.g., contact information of the various users, data on preferences of the users as well as article acquisition history data of the various users. Also at send block 1102, manager system 110 can be sending query data for receipt by enterprise systems 150A-150Z. Enterprise systems of enterprise systems 150A-150Z can include, e.g., banking and institution enterprises that can record for various users of system article acquisition data so that manager system 110, by acquiring such article acquisition data, can build profile information of various users that specify article acquisition histories of the various users and receipt of the described query data. Enterprise systems of enterprise systems 150A-150Z can include, e.g., an article providing enterprises that can record for various users of system article acquisition data so that manager system 110, by acquiring such article acquisition data, can build profile information of various users that specify article acquisition histories of the various users and receipt of the described query data. Enterprise systems 150A-150Z at send block 1501 can be sending user data to manager system 110.

On completion of block 1103, manager system 110 can proceed to send block 1104. At send block 1104, manager system 110 can be sending query data to UE devices 130A-130Z and can also be sending query data to IoT devices 140A-140Z. In response to the received query data, UE devices 130A-130Z can be sending functional space data to manager system 110 for processing by manager system 110. The functional space data can specify information of functional spaces associated to the various users, e.g., rooms within a residence of the various users of respective users of system 100. The functional space data can include camera images, image representations of functional spaces associated to a venue of the user, e.g., residence, office, operations facility that specifies dimensional information of functional spaces associated to a user, including on occupied regions of such functional spaces (as may be occupied by prior acquired articles). In response to the query data sent at block 1104 to IoT devices 140A-140Z, IoT devices 140A-140Z can be sending at send block 1401 functional space data to manager system 110 for processing. On receipt of the functional space data sent at block 1304 and block 1401, manager system 110 at updating block 1105 can be performing updating of space profiles associated to various users of system 100. The functional space data sent at block 1401 can include, e.g., camera image representations of functional spaces associated to users as captured by home robots of the respective users. The functional space data can include spatial data regarding the boundaries of such spaces, e.g., as delimited by walls, as well as spatial information on occupied regions of spatial spaces. Embodiments herein recognize that characteristics of functional spaces can be changing over time. Function space data can be queried from IoT devices, e.g., robots at functional spaces. Robot herein can include, e.g., an automated robotic vacuum cleaner that regularly cleans floors associated to functional spaces of the various users of system 100.

On receipt of the functional space data sent at block 1304 and block 1401, manager system 110 at updating block 1105 can perform updating of functional space profiles associated to the various users of system 100.

As seen with respect to return block 1120, manager system 110 can iteratively be performed in a loop including updating block 1103 and 1105 iteratively over time so that manager system 110 can iteratively update user profiles and space profiles associated to the various users as changes are made, e.g., as preferences are made, as preferences change for users over time, as article acquisitions progress over time, and as changes are made to functional spaces associated to the users, e.g., by space reconfiguration, the acquisition of additional articles, the removal of articles, and so on.

On completion of updating block 1105, manager system 110 can proceed to block 1106. At send block 1106, manager system 110 can be sending query data for receipt by enterprise systems 150A-150Z. On receipt of the query data, enterprise systems 150A-150Z can be sending article data for receipt by manager system 110. On receipt of the article data, manager system 110 can perform updating of article profiles associated to the various articles at updating block 1107. The article data can include, e.g., product article manual information, product article instruction information, product article lists, product article specification sheets, and so forth that specify dimensions of articles.

In another aspect, manager system 110 at send block 1106 can additionally, or alternatively, be sending query data for receipt by UE devices 130A-130Z and/or IoT devices 140A-140Z. These UE devices 130A-130Z and/or IoT devices 140A-140Z on receipt of the query data can send, e.g., camera image representations of articles in use in functional spaces. Such data can be subject to processing by manager system 110 in the performing of updating of article profiles at block 1107. The additional described article data received from IoT devices 130A-130Z and/or IoT devices 140A-140Z can be processed to determine dimensional information specified for various articles that may differ from, e.g., article manuals, article instruction manuals, or article specifications.

It will be seen that manager system 110 can iteratively be performing the loop that comprises updating blocks 1103, 1105 and 1107 on an iterative basis throughout the deployment period of manager system 110 so that information on users, functional spaces, and articles can be iteratively updated by manager system 110 throughout the deployment period of manager system 110. In one embodiment, UE devices 130A-130Z and/or IoT devices 140A-140Z queried for updating functional space data at block 1105 and/or article data at block 1107 can include respective point cloud image sensors that return point cloud three dimensional (3D) image data. Embodiments herein recognize that use of point cloud 3D image data can benefit processing of image data for return of dimensional information of functional spaces and/or articles represented therein.

On completion of updating block 1107, manager system 110 can proceed to training block 1108. At training block 1108, manager system 110 can train one or more predictive model based on data obtained as a result of preceding query block 1102, 1104, and/or 1106.

On completion of training block 1108, manager system 110 can proceed to acquisition block 1109. At acquisition block 1109, manager system 110 can determine whether a user has selected an article for acquisition. At acquisition block 1109, manager system 110 can be processing received user data received from respective ones of UE devices 130A-130Z which user data can be iteratively sent at send block 1305 by UE devices 130A-130Z. The user data sent at block 1305 can include, e.g., user browser data that references online article related actions by user, e.g., the placement of an article into an online shopping cart and/or completing checkout of the selected article. At acquisition block 1109, manager system 110 can determine that an article has been selected for acquisition, e.g., when an article has been placed in an online shopping cart, which can be determined by manager system 110 examining user browser data. While an online acquisition scenario is depicted, embodiments herein can include live, e.g., not online article acquisition selection, e.g., the presentment of a live article into a real-world shopping cart is detected, e.g., by a venue camera defining an IoT device of IoT devices 140A-140Z. Referring to acquisition block 1109, manager system 110 at acquisition block 1109 can determine that an article has been selected for acquisition when the article has been placed in an online shopping cart by the processing of received user data provided by user browser data.

Manager system 110 can iteratively perform acquisition block 1109 until the time an article acquisition selection has been detected and determined. As indicated by the loop associated to block 1109, manager system 110 can be iteratively processing user data, e.g., user browser data until the time that an article acquisition selection event has been detected. On the determination that an article has been selected for acquisition, manager system 110 can proceed to block 1110.

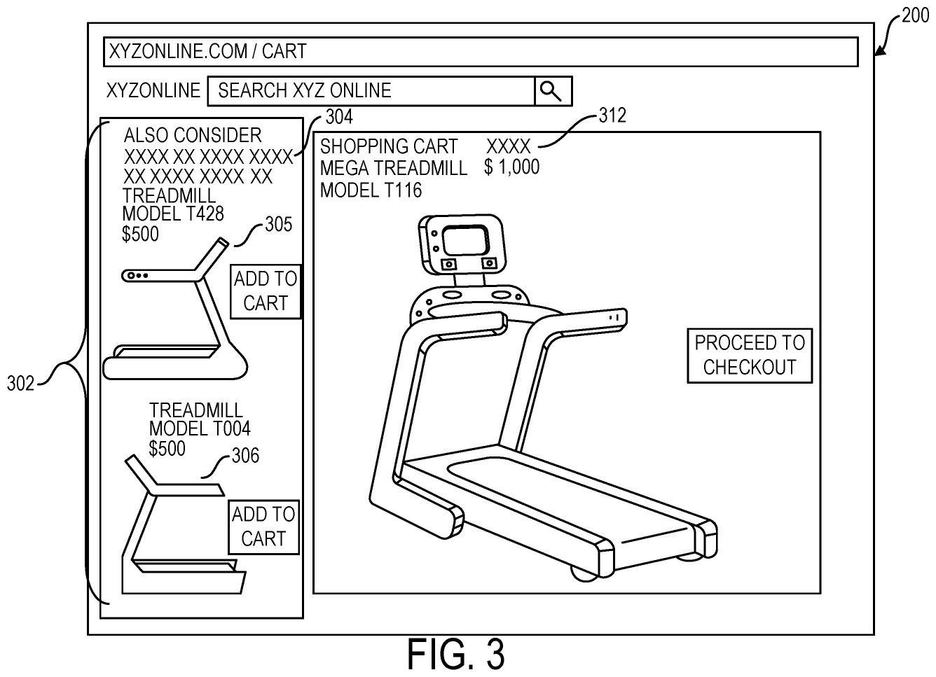

In one example, in reference to blocks 1109 and 1110, a user can be performing online article acquisition with use of user interface 200 as set forth in FIG. 3. User interface 200 in one embodiment can be provided by a served webpage provided by or on behalf of an article provider and served by a server operated by or on behalf of the article provider. User interface 200 can be displayed by a UE device browser on a display of a UE device of UE devices 130A-130Z associated to various users of system 100. The user can place an article, e.g., the depicted model T116 treadmill in an online shopping cart and based on such action detected by processing user browser data, manager system 110 at block 1109 can detect and determine that the user has selected the model T116 treadmill for acquisition. In the determination that the article has been selected for acquisition, manager system 110 can proceed to block 1110.

At block 1110, manager system 110 can compare text tags that have been associated to the model T116 treadmill in articles area 2123 of data repository 108 to text tags that have been associated to various functional spaces recorded in spaces area 2122 associated to the current user. In one example, text tags associated to the selected treadmill T116 can include such tags as, e.g., treadmill, heartrate, running, exercise, jogging, include, fitness, workout . . . and the like.

At block 1110, manager system 110 can perform identifying of a functional space associated to a user who performed the article selection determined at the prior iteration of block 1109. Identifying at block 1110 can include comparing text tags associated to both the article for acquisition selection as detected at block 1109 and the functional space identified at block 1110. At identifying block 1110, manager system 110 can be subjecting multiple candidate functional spaces to spaces of the user associated to block 1109, i.e., can be comparing text tags of the article for acquisition detected at block 1109 to text tags associated to each candidate functional space of a set of candidate functional spaces, and at block 1110, manager system 110 can select the functional space out of the candidate functional spaces having the strongest text tag association to the article selected for acquisition subject to processing at block 1109.

Referring to Table A, manager system 110 can perform natural language processing to compare text tags of an article selected for acquisition by a user to different candidate functional spaces associated to the user.

TABLE A

| | | Candidate | Functional space | |
|---|---|---|---|---|
| Article | Article text tags | functional space | text tags | Percent hits |
| treadmill | Treadmill, | kitchen | Cooking, | 0.04 |
| | heartrate, running, | | appliances, cabinet, | |
| | exercise, jogging, | | dishes, utensils, | |
| | include, fitness, | | food . . . | |
| | workout . . . | | | |
| treadmill | Treadmill, | home gym | Fitness, equipment, | 0.32 |
| | heartrate, running, | | weights, treadmill, | |
| | exercise, jogging, | | workout, exercise . . . | |
| | include, fitness, | | | |
| | workout . . . | | | |
| treadmill | Treadmill, | home office | Desk, chair, | 0.03 |
| | heartrate, running, | | computer, laptop, | |
| | exercise, jogging, | | filing cabinet . . . | |
| | include, fitness, | | | |
| | workout . . . | | | |
| treadmill | Treadmill, | garage | Car, workbench, | 0.07 |
| | heartrate, running, | | storage, tools, | |
| | exercise, jogging, | | bicycles . . . | |
| | include, fitness, | | | |
| | workout . . . | | | |

Referring to Table A, manager system 110 at block 1110 can identify the candidate functional space of “home gym” of the user as the functional space associated to the article selected for acquisition, based on “home gym” functional space returning the highest percentage of hits out of the functional spaces evaluated by comparison of text tags as set forth in Table A.

Based on the functional space of “home gym” associated to the current user being selected, manager system 110 on completion of block 1110 can proceed to assessing block 1111. At assessing block 1111, manager system 110 can assess whether the selected treadmill T116 depicted in FIG. 3 can be fitted within an open area of the functional space of the current user associated to the selected model T116 treadmill. For performing such assessing at block 1111, manager system 110 can pull from spaces area 2122 of data repository 108 functional space dimensional data that has been accumulated for the identified functional space associated to the selected model T116 treadmill, and can pull from articles area 2123 dimensional data of the selected article for acquisition. Table B depicts example data that can be pulled from articles area 2123 of data repository 108.

TABLE B

| Article | Article | | | | |
|---|---|---|---|---|---|
| model | type | Article | Article | Article | |
| number | classification | keywords | dimensions | remarks | . . . |
| T116 | treadmill | XXXX, | XXXX, | XXXX, | . . . |
| | | XXXX . . . | XXXX . . . | XXXX . . . | |

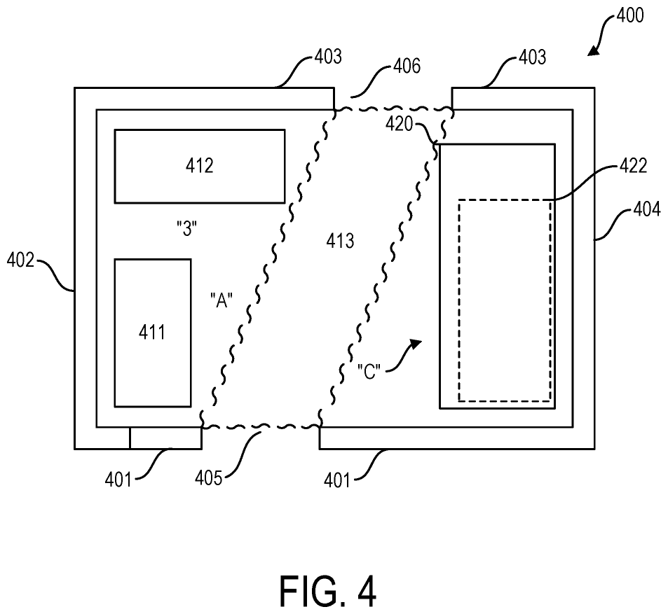

Referring to FIG. 4, the functional space attributes accumulated for the identified functional space as pulled from articles area 2123 can include the dimensional attributes depicted in FIG. 4. The functional dimensional attributes data can include map 400 that specifies dimensions of the identified functional space for the selected article, in this case, the functional space home gym. Functional space attributes of the functional space depicted in FIG. 4 can include, e.g., walls 401, 402, 403, 404, and entryways 405 and 406. The walls and access ways depicted in FIG. 4 can have actual dimensions, e.g., distances X, Y, and Z depicted proportionally that are proportional to the distances depicted in FIG. 4.

Referring further to FIG. 4, the depicted functional space can also include occupied zones 411, 412 and 413, wherein zones 411 and 412 are zones, e.g., of previously acquired home gym equipment articles and zone 413 is a detected foot traffic zone as detected, e.g., by processing of camera image data or alternative sensing data sensed, e.g., by a home robot such as a home vacuum cleaner.

The depicted functional space can also include various candidate open areas such as candidate open area A, candidate open area B, and candidate open area C where candidate open area A is the area between article zone 411 and foot traffic zone 413, and candidate open area B is an open area between article zone 411 and article zone 412. Candidate open area C can generally refer to the open area between foot traffic zone 413 and wall 404.

Referring further to the functional space data depicted in FIG. 4, footprint 420 can refer to the top-view dimension of the current article selected for acquisition, which in the use case described is a model T116 treadmill depicted in FIG. 3. Referring to FIG. 4, manager system 110 can pull dimensional information of the selected model T116 treadmill as depicted in FIG. 3, and from articles area 2123 and data repository 108 can compare the dimensional information of the selected article to dimensional information of the current functional space being considered, i.e., the home gym functional space depicted in FIG. 4 in a manner as depicted in reference to FIG. 4. Referring to footprint 420 of the selected model T116 treadmill, manager system 110 can compare dimensions of footprint 420 which can be a top viewed front footprint to the top view open areas A, B, and C as depicted in FIG. 4 comparing the dimensions of footprint 420 to open areas A and B. Manager system 110 can determine that the open areas A and B are too small to accommodate footprint 420 and so, manager system 110 can proceed to evaluate and assess at assessing block 1111 footprint 420 in reference to open area C.

Manager system 110, in performing the assessment of each open area can rotate footprint 420 to various orientations to test different possible orientations of footprint 420 within each open area.

In one example, manager system 110 performing assessing at block 1111 can include manager system 110 determining that an article is qualified to be fitted within an open area when manager system 110 determines that there is sufficient area within an open area to accommodate an article. In such an example, manager system 110 can disqualify an article for fitting when the article is too large to be fitted within an open area of a functional space. In another example, manager system 110 can be configured to disqualify an article selected for acquisition for fitting into an open area when the article selected for acquisition is unnecessarily small for purposes of being fitted into an open area of a functional space. In other words, manager system 110 can be configured to disqualify an article when manager system 110 detects that there is a threshold exceeding the amount of additional space that can be utilized by a selected article for acquisition. In the example of FIG. 4, manager system 110 considers X and Y dimensions in performing fitting assessment. In another example, manager system 110 can also, or alternatively, consider Z dimension (height) when performing assessing. Manager system 110 can perform Z dimension assessing, e.g., when assessing placement of an article on a countertop under a kitchen cabinet, on a shelf or a table. In one particular use case, manager system 110 can perform Z dimension assessing (with X and Y dimension assessing), e.g., when assessing placement of one or more article provided by computer hardware devices, e.g., computer servers, and/or computer server racks, within a functional space associated to a data center. In such a scenario a user can be an agent user of an enterprise that operates such data center.

Manager system 110 in performing assessing at block 1111 can also perform text based processing of article data recorded in articles area 2123 describing special instructions for arrangement of the article and can note, for example, that the referenced treadmill has a recommended standoff distance from functional space walls. On testing various orientations, manager system 110 can determine that footprint 420 of the selected treadmill is too large to be accommodated within the functional space depicted in FIG. 4. i.e., by way of the depicted encroachment onto foot traffic zone 413 as depicted in FIG. 4. Thusly, manager system 110 at block 1112 can return the decision that the article being assessed is too large to be fitted into a functional space and based on determining at block 1112 that an open area is not available within the functional space sufficient to accommodate the selected article, manager system 110 can proceed to discovering block 1113.

At discovering block 1113, manager system 110 can discover alternative articles of the same article classification of the selected article, but of different dimensions. To perform such discovering, manager system 110 can examine dimensional, e.g., footprint data of alternative candidate articles of the same article classification of the selected article. For performance of discovering block 1113, manager system 110 can call and examine article dimensional data that has been accumulated into articles area 2123 of data repository 108 for articles of a common article classification with the originally selected article. Manager system 110 performing discovering block 1113 can include manager system 110 calling candidate articles for evaluation from articles area 2123 of data repository 108 having a common article type classification as the article determined to be selected for acquisition at block 1109. In the performing of discovering block 1113, manager system 110 using the called dimensional information from articles area 2123 can subject each accessed candidate article having the same article classification as the originally selected article for acquisition to the assessing process described with reference to footprint 420 and the open areas A, B, and C described in reference to FIG. 4, i.e., can attempt to fit the described respective candidate articles within the described open areas A, B, and C, trying different orientations. Manager system 110, at the described discovering block 1113, can qualify an article as being qualified for fitting within an open area on the determination that the candidate article can be fitted into an open area as depicted in FIG. 4. On performing of discovering at block 1113, according to one embodiment, manager system 110 can determine that one or more alternate candidate treadmill having footprint 422 can be fitted in the open space “C” of the functional space depicted in FIG. 4.

On completion of discovering block 1113, manager system 110 can proceed to ranking block 1114. At ranking block 1114, manager system 110 can rank discovered candidate alternative articles that have been discovered at block 1113. For performance of the ranking at ranking block 1114, manager system 110 can consider multiple factors. Manager system 110 at ranking block 1114 can apply a multi-factor scoring evaluation as described in connection with Equation 1.

S=F1W1+F2W2 (Eq. 1)

Referring to Equation 1, Factor F1 can be a first factor, factor F2 can be a second factor and W1, W2 can be weights associated to factor F1 and factor F2 respectively. In one embodiment, F1 can be a size factor and F2 can be an observed performance compatibility factor as determined by examining article review data.

Manager system 110 can score alternative articles according to size factor F1 in dependence on the level of similarity of the size of the alternative article to the size of the previously selected article for acquisition at the prior iteration of block 1109. Accordingly, in one embodiment, where manager system 110 qualifies an article for fitting when there is sufficient space to accommodate the article, manager system 110 can scale assigned scores to articles under factor F1 according to their size, with relatively higher scoring values assigned to alternate articles that are relatively larger but still able to be fitted in a functional space being evaluated than are assigned to smaller alternative articles that can be fitted into the functional space.

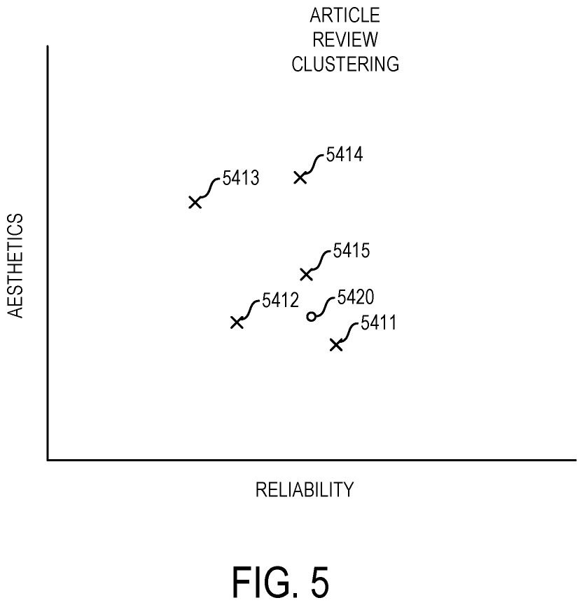

Under factor F2 as described in connection with Eq. 1, manager system 110 can perform clustering analysis as set forth in reference to FIG. 5. With reference to FIG. 5, there are depicted first and second characteristic dimensions of article reviews that have been accumulated for the originally selected article, i.e., model T116 treadmill and the alternative articles discovered by performance of discovering block 1113. In one aspect, article data accumulated in articles area 2123 resulting from iterations of query data, sending block 1106 can include article review data posted, e.g., on social media websites and/or enterprise websites. With regard to block 1106, query data for return of return article data can be sent to social media system 160, enterprise systems 150A-150Z, and (though not depicted in FIG. 2A-2B) UE devices 130A-130Z.

Referring to FIG. 5, the originally selected article can be plotted as data point 5420 having the depicted dimensions in terms of article review criterion of reliability and aesthetics as depicted in FIG. 5 while data points 5411, 5412, 5413, 5414, 5415 can be data points plotting the reliability and aesthetics dimensions for the alternative articles identified at discovering block 1113. Manager system 110 under factor F2 can assign article similarity scores in accordance with the clustering analysis depicted in FIG. 5 and based on the depicted Euclidean distance between the data points, can assign the candidate article associated to data point 5411 the highest score under factor F2 based on Euclidian distance, with next highest scores being assigned in the order of Euclidean distance so that data point 5415 is assigned the second highest score under factor F2, data point 5412 the third-highest, data point 5414 the fourth highest, and data point 5413 the fifth highest based on Euclidean distance.

For completion of ranking block 1114, manager system 110 can rank candidate alternative articles based on scores assigned by manager system 110 on application of Eq. 1. With further reference to FIG. 5, it is seen that clustering analysis in the depicted example can include first and second dimensions. However, it will be recognized that the clustering analysis depicted in FIG. 5 can be expanded to N dimensions, e.g., including other article review dimensions such as ease-of-use, cost, ease of assembly and the like. In FIG. 5, the depicted dimension strengths can be based on, e.g., average star ratings across various review categories.

Upon completion of ranking block 1114, manager system 110 can proceed to prompting block 1115. At prompting block 1115, manager system 110 can generate prompting data that specifies to a user that one or more alternative articles can be selected. The prompting data generated at block 1115 can be in dependence at discovering block 1113 and the ranking at ranking block 1114.

On completion of prompting block 1115, manager system 110 can proceed to send block 1116. At send block 1116, manager system 110 can send prompting data for presentment on user interface 200 as shown in FIG. 3. The generated prompting data can include prompting data 302 as shown in FIG. 3. In the example of FIG. 3, manager system 110 disqualifies and sets an alert when determining that the selected model T116 treadmill is too large to fit into open area C as depicted in FIG. 4.

Referring to prompting data 302 as set forth in FIG. 3, prompting data 302 can include text based prompting data and graphics based prompting data. Graphics based prompting data can include graphics such as graphics 305 and graphics 306 depicting an alternate article for selection. The text based prompting data included within prompting data 302 can include variable text based prompting data 304. The variable text based prompting data 304 can include text that specifies to a user on user interface 200 information regarding the alternate articles identified for possible selection. In one use case, the variable text based prompting data 304 in FIG. 3 can specify, e.g., as follows: “Zach, your selected treadmill may be too large for your home gym, please consider the following alternatives.”

In one aspect, the variable text based prompting data 304 can specify the functional space (your “home gym”) identified as being associated to the article selected for acquisition.

In another aspect, the variable text based prompting data 304 can specify a reason as to why the selected article for acquisition was determined to be not suitable and not accommodatable within a functional space, e.g., the text based variable prompting data 304 can specify that the selected article for acquisition is too large for a functional space, or alternatively, can specify that the selected article for acquisition will leave the threshold exceeding the amount of additional space in an open area. In the latter situation, the variable prompting data 304 can specify as follows, e.g., “Zach, there is room for a larger treadmill in your home gym.”

In another aspect, the text based variable prompting data 304 can personalize and customize the text based message and call out the name of the user, e.g., “Zach” in the described scenario associated to a current article acquisition.

The articles depicted within prompting data 302 can be presented in an order according to the ranking performed at ranking block 1114, and as described in reference to ranking process 119 set forth in reference to Eq. 1. In presenting representations of articles in an order according to a performed ranking, manager system 110 can present a higher ranked article in a hierarchical order before the next ranked article. Therefore, within prompting data 302, manager system 110 can present the article represented by prompting data 305, which is ranked higher at a higher elevation within a displayed user interface 200 than the relatively lower ranked article represented by prompting data 306. In one embodiment, the prompting data 302 can be expanded to present to the user the functional space map 400 depicted in the FIG. 4 with the fitment of articles as described in connection with FIG. 4 presented to the user so that the user has a fuller appreciation of the fitment issues in the identified functional space.

In response to presented prompting data which can be sent at block 1116, a user at send block 1306 can send selection data specifying an alternative article selection by the user. At block 1117, manager system 110 can detect whether the user has made any change in selection of an article for acquisition, e.g., can determine whether the user has added a different article for acquisition to a shopping cart.

On manager system 110 determining that a user has added an alternative article for selection to a shopping cart, manager system 110 can return to a stage preceding block 1109 and can proceed to subject the new article selected for acquisition to processing at subsequent blocks 1110 through 1116 as described in connection with the earlier article selection, the model T116 treadmill. That is, in the case that the alternative article selected for acquisition is another treadmill, manager system 110 can assess open areas A, B, and C as described in connection with FIG. 4 again to ascertain whether the alternative article can be accommodated within a functional space identified as being associated to the alternatively selected article.

Manager system 110 can iteratively perform the loop of blocks 1109 to 1117 for a time that the user continues to make changes in response to prompting data generated and sent to a user at block 1116. On the determination that changes have not been made to a user's article selections, manager system 110 at block 1117 can proceed to block 1118. At block 1118, manager system 110 can ascertain whether a user's article acquisition selections have been confirmed.

At block 1118, manager system 110 for confirming completion of an article acquisition can ascertain, e.g., via examining of user browser data, whether the user has proceeded to check out and has finalized checkout of selected article(s) for acquisition. If the user has not finalized acquisition, manager system 110 can iteratively perform the loop of blocks 1109 to 1118 for a time that a user has not finalized article acquisition.

On the determination that a user has finalized acquisition at block 1118, e.g., by finalizing online checkout, manager system 110 can proceed to training block 1119. At training block 1119, manager system 110 can apply a next iteration of training data to a predictive model for predicting behavior of users. At training block 1119, according to one specific example, manager system 110 can apply a set of training data defined by the acquired one or more article confirmed at block 1118 to a predictive model that predicts an additional one or more article to be acquired in connection with a selected article. On completion of training block 1119, manager system 110 can proceed to block 1120.

At block 1120, manager system 110 can return to a stage preceding block 1101 so that manager system 110 is able to receive and process the next iteration of registration data from new or existing users who are using UE devices 130A-130Z. Manager system 110 can iteratively perform the loop of blocks 1101 to 1120 during a deployment period of manager system 110. Manager system 110 can be iteratively performing the loop of blocks 1101 to 1120 for multiple users and multiple acquisitions simultaneously and concurrently. As set forth in reference to block 1107, article data iteratively received by manager system 110 can include article review data, e.g., article review data that specifies user, comment on used articles across various attribute classifications, e.g., aesthetics, ease-of-use, reliability, etc.

In one aspect, as explained with reference to dimension adjusting process 114, manager system 110 can adjust a recorded dimension for an article subject to assessment in dependence on text based review data associated to the article. Accordingly, in performing assessing at block 1111, manager system 110 can adjust a recorded size of an article being assessed for fitting into an open area of a functional space in dependence on text based remarks for the article, e.g., appearing in the text based review of the article by users of a crowdsourced collection of users of system 100. In one example, where a threshold satisfying percentage of reviews are tagged with topics indicating that the article is functionally larger than expected, manager system 110 can increase a recorded dimension for the article, i.e., relative to recorded baseline dimensions for the article as determined from baseline text documents such as article specifications, instruction manuals, and the like.

Where text based review data has been tagged with topics indicating that the article is functionally smaller than the recorded baseline dimensions for the article as recorded by processing of baseline document, manager system 110 can decrease recorded dimensions for the article when performing assessing at block 1111.

Referring to the flowchart of FIGS. 2A and 2B, manager system 110 can be iteratively performing the loop of blocks 1101 to 1120 for a deployment period of manager system 110. UE devices 130A-130Z can iteratively be performing the loop of blocks 1301 to block 1307 for a deployment period of UE devices 130A-130Z. IoT devices 140A-140Z can be iteratively performing the loop of blocks 1401 to 1402 for a deployment period of IoT devices 140A-140Z. Enterprise systems 150A-150Z can iteratively be performing the loop of blocks 1501 to 1503 for a deployment period of enterprise systems 150A-150Z. Social media system 160 can be iteratively performing the loop of blocks 1601 to 1603 for a deployment period of social media system 160.

On the determination at block 1112 that a selected article for acquisition can be fitted within a functional space, manager system 110 can bypass blocks 1113 and 1114 as set forth in the flowchart of FIGS. 2A to 2B and proceed to block 1115 to generate prompting data. The prompting data generated at block 1115 where blocks 1113 and blocks 1114 are bypassed can include prompting data provided by positive reinforcing text that specifies to a user that the selected article for acquisition can positively be fitted and accommodated within a functional space. For example, referring to FIG. 3, variable text based prompting data 312 can include the text based message, e.g., “Zach, I'm happy to report that your selected treadmill will fit well within your home gym.” Such prompting data defines prompting data for prompting acquisition of an article selected for acquisition.

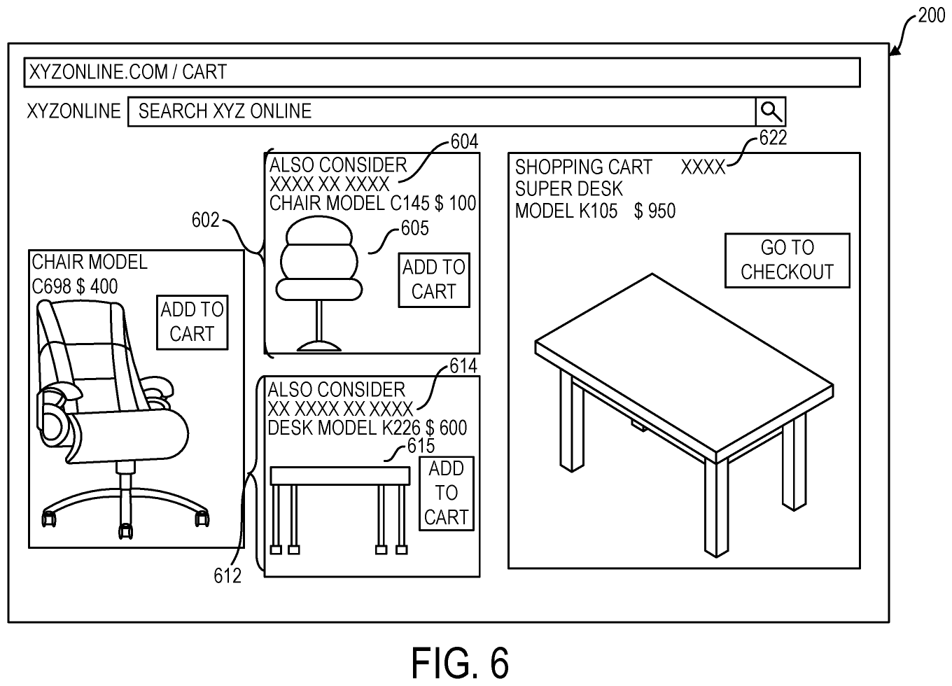

Additional aspects of system 100 and manager system 110 are set forth in reference to FIGS. 6, 7, and 8. As set forth in reference to article predicting process 115 described in reference to FIG. 1, manager system 110 can ascertain that the user will acquire a complementary article when selecting an article for acquisition.

When a user has selected an article for acquisition, e.g., the desk K105 indicated in FIG. 6, manager system 110 can ascertain that the user will acquire one or more complementary article that is complementary to the article selected for acquisition. Manager system 110 on identifying a functional space associated to the article using the method described in reference to Table A can ascertain a complementary one or more article that the user will acquire in addition to the selected article. In the described example of FIG. 6, manager system 110 at identifying block 1110 can identify the functional space of home-office as being associated to the selected article of a desk using the method described in reference to Table A.

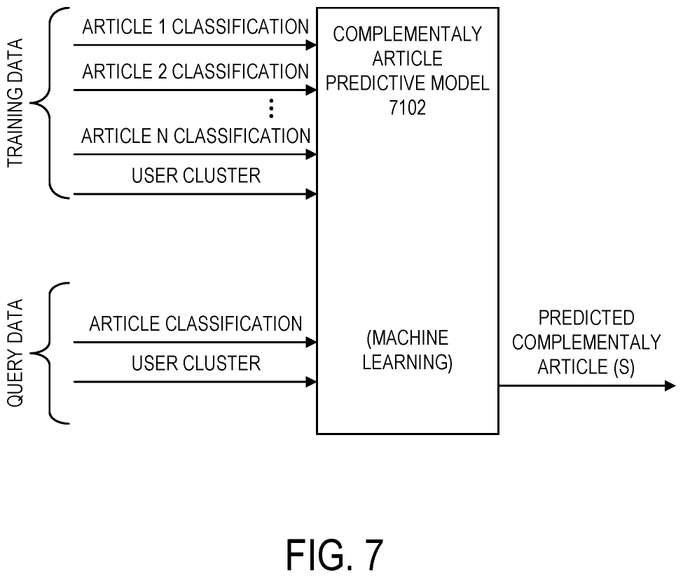

Manager system 110 for predicting a complementary article associated to the selected article can query the machine learning trained predictive model 7102 set forth in reference to FIG. 7. Complementary article predictive model 7102 can be trained with training data to predict complementary article(s) to be acquired in addition to a selected article. Complementary article predictive model 7102 can be trained with iterations of training data. Iterations of training data for training complementary article predictive model 7102 can include identifiers of articles. An iteration of training data for training complementary article predictive model 7102 can include (a) article classifications of all articles acquired by a user during a specified time window in combination with (b) a user cluster identifier for the user acquiring the aforesaid articles. For example, over a 30-day time, the user may acquire N articles each having a different article classification. The classifications, being, e.g., desk, chair, treadmill, and the like and the user cluster can specify a preference cluster for a given user. The described iterations of training data can be applied on an on-going iterative basis for all registered users of system 100 and can be applied on a rolling time window basis. For example, on day 1, manager system 110 can apply the described training dataset for all users with a 30-day time window look back to encompass all article acquisitions for each given user within the previous 30 days. Then on day 2, manager system 110 can reapply the training datasets for all users for another 30-day look back time window, this time with the rolling time window being adjusted by one day. Trained as described, complementary article predictive model 7102 can learn relationships between articles that are commonly acquired on a complementary basis in combination with one another, e.g., a printer in combination with the printer stand, weightlifting bench in combination with dumbbells, yoga mat in combination with yoga block, office desk in combination with office chair, server in combination with server rack and fan, and the like.

Trained as described, complementary article predictive model 7102 is able to respond to query data. Query data for querying complementary article predictive model 7102 can include an article classification for a current article selected for acquisition, e.g., the classification of desk for the example of FIG. 6 in combination with a user cluster identifier. In response to the query data, complementary article predictive model 7102 can return a prediction as to the predicted complementary one or more article that is predicted to be acquired along with the article selected for acquisition. Complementary article predictive model 7102 can be configured to assign confidence scores to the articles predicted to any complementary article predicted for acquisition. The confidence values can be assigned on a scale of 0.0 to 1.0. Manager system 110 can be configured to ascertain that an additional complementary article will be acquired when the confidence level satisfies a threshold. The confidence levels can be determined, e.g., in dependence on the volume of training data for articles of the classification predicted for acquisition has been previously applied to complementary article predictive model 7102.

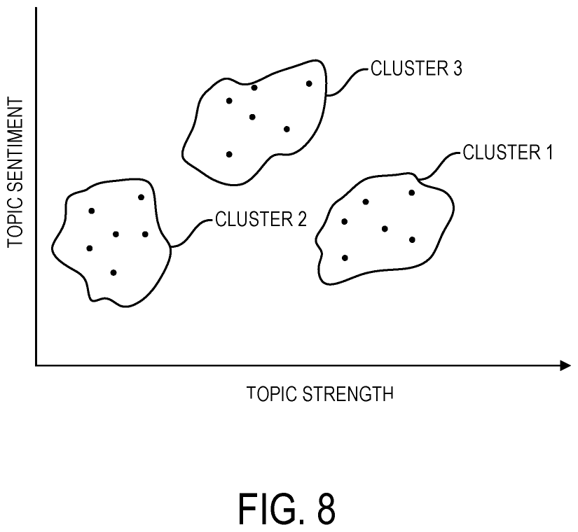

The user cluster referred to in FIG. 7 can refer to a type of classification of a given user. Manager system 110 can establish a user cluster for any user of system 100 by application of clustering analysis as set forth in FIG. 8. Over time at updating block 1103, manager system 110 can be iteratively updating clustering analysis for clustering and classifying users as set forth in FIG. 8. For performing clustering analysis illustrated in FIG. 8 for identification of common types of users, manager system 110 can be digesting text based documents associated to all users. The text based assets can include, e.g., social media posts of the various users as acquired from social media system 160 as well as other text based assets of the various users including text based assets acquired via acquisition of registration data sent at block 1301 and any text based article reviews posted by users acquired from enterprise systems 150A-150Z as indicated by send block 1501. Manager system 110 can be subjecting all text based assets of all users to natural language processing for extraction of a topic strength of one or more key topic as well as sentiments associated to such topics.

FIG. 8 depicts plotted dimensional data points for multiple users of system 100 for a designated key topic. For the key topic, manager system 110 can assign a topic strength value and a topic sentiment value. Manager system 110 can apply topic strengths as indicated in FIG. 8 in dependence on account of times the key topic is extracted per predetermined volume of asset data, e.g., based on a count of topic extractions for every 1000 words. Manager system 110 can apply a topic sentiment by performance of sentiment extraction using natural language processing on text based content associated to respective key topic extractions. Manager system 110 can identify clusters of users by their close proximity in Euclidean space, and can assign the clusters various cluster identifiers, e.g., cluster 1, cluster 2, and cluster 3 as depicted in FIG. 8. Referring to FIG. 8, manager system 110 can assign sentiment values to users for the key topic depicted on a scale, e.g., of 0.0 to 1.0 with values from 0.0 to 0.5 being negative sentiment values, the value of 0.5 being a neutral sentiment, and the values 0.5 to 1.0 being positive sentiment values.

While a single key topic is depicted in FIG. 8, manager system 110 can expand the clustering analysis across additional dimensions defined by additional key topics.

Referring again to the example of FIG. 6 and the flowchart of FIGS. 2A to 2B, manager system 110 at assessing block 1111 in one scenario can query complementary article predictive model 7102 to ascertain that the current user is predicted to acquire an office chair, in addition to the expressly selected article for acquisition desk model K105 depicted in FIG. 6. On ascertaining that an additional complementary article will be acquired, manager system 110 in performing assessing at block 1111 can include the additional one or more complementary article in the fitment assessment. Embodiments herein recognize that different types of users can have different article acquisition behavior. Training complementary article predictive model 7102 with use of a user cluster identifier can result in complementary article predictive model 7102 to return different predictions in dependence on the type of current user. Different predictions as to a complementary article to be acquired in dependence on the user type (determinable by clustering analysis depicted in FIG. 8) of the current user.

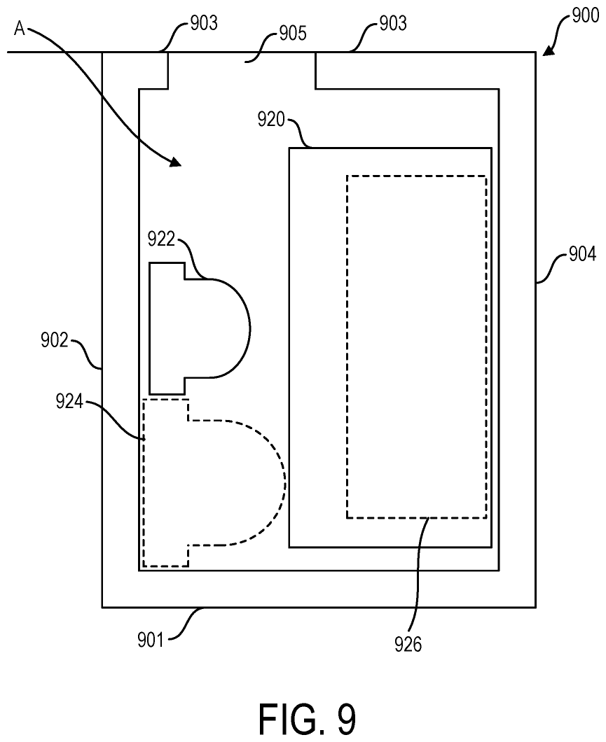

Manager system 110, when ascertaining that a complementary one or more article will be acquired, can perform fitting assessing at block 1111 in a manner set forth in FIG. 9. In reference to FIG. 9, manager system 110 can perform space fitting assessment with respect to multiple articles, e.g., a selected article for acquisition, e.g., the desk K105 depicted in FIG. 6 plus one or more complementary additional article predicted for acquisition. In reference to FIG. 9, the functional space depicted by map 900 is the identified functional space associated to the current user of home-office as identified by identifying block 1110 using the method of Table A. Map 900 as shown in FIG. 9 depicts walls 901, 902, 903, and 904 of a functional space defining a home-office as well as entryway 905 and defining open area A. Referring to map 900, the depicted relative space consumptions of walls and articles depicted in map 900 can correspond to the scaled real world dimensions of the walls and articles depicted.

On ascertaining the selecting of acquisition of desk K105 by a user depicted in FIG. 6, manager system 110 can attempt to fit footprint 920 called from articles area 2123 associated to the selected desk into open area A of the functional space depicted by map 900. Manager system 110 in performing such fitment assessment can try various alternative orientations. In dependence on ascertaining that a chair will also be acquired, manager system 110 can further attempt to fit a candidate chair having top view footprint 922, along with desk represented by footprint 920 into open area A of the functional space as shown in FIG. 9.

Manager system 110 can identify candidate additional articles for possible fitment into the functional space by employing processing described with respect to discovering block 1113 and can test for fitment multiple different candidate additional complementary articles. Manager system 110 can also rank alternative additional articles by use of Eq. 1 and present a ranked list within prompting data. On determination that the candidate additional complementary article defining a chair having footprint 922 can be fitted into the described open area of FIG. 9, manager system 110 can present the prompting data 602 depicted in FIG. 6. While X, Y dimension functional space fitment assessments are depicted in FIGS. 4 and 9, manager system 110 can additionally, or alternatively, perform Z dimensional space, i.e., height space dimensional fitments of articles.

Prompting data 602 as depicted in FIG. 6 can prompt the user to select for acquisition chair model C145, which is graphically depicted by graphical prompting data 605 and being associated to footprint 922 evaluated and assessed as fitting with the previously selected desk selected for acquisition by the user having footprint 920. Further with reference to FIG. 6, variable text data 604 within prompting data 602 can specify to the user, e.g., as follows. “Zach, we noticed that the desk that you have selected is large and creates relatively little space for an office chair. We have therefore recommended the following modest size chair for your home office.”

In the described scenario, the user Zach may not like the modest size chair prompted for selection by prompting data 602, but instead may prefer chair model C698 depicted in FIG. 6, which Zach has been viewing in the background while using user interface 200 defined by the depicted XYZOnline webpage. Zach, in the described scenario, may then move the larger luxury chair represented as model C698 into the current shopping cart whereupon manager system 110, by operation of iteration of change evaluation block 1117, returns to the loop including block 1111 to perform space assessment of the large selected desk K105 with a large selected chair C698. Where manager system 110 discovers multiple suitable alternate chairs and with further reference to prompting data 602, prompting data 602 can include text based and graphics data prompting data that specifies ordered ranking of such alternate articles which can be ranked using Eq. 1. Such multiple articles specifying prompting data can be configured according to prompting data 302. In one embodiment, the prompting data 602 can be expanded to present to the user the functional space map 900 depicted in FIG. 9 with the fitment of articles as described in connection with FIG. 9 presented to the user so that the user has a fuller appreciation of the fitment issues in the functional space.

At the next iteration of assessing block 1111, manager system 110, with reference to FIG. 9, can assess fitment of the large selected desk (model K105) having footprint 920 in combination with a large selected chair (model C698) having footprint 924. In performing such assessing at block 1111, manager system 110 can, in one embodiment, increase the recorded dimensions of the chair having footprint 922 in dependence on natural language processing of text based review remarks indicating that the selected chair has a functional dimension larger than the dimensions as extracted from baseline documentation, e.g., by reason of its swivel and or tilting capacities. Manager system 110 in the described scenario in performing fitment assessment of the desk having footprint 920 with the chair having footprint 924 can determine that area A will not accommodate both articles together and can, therefore, generate next prompting data 612 as depicted in FIG. 6.

Next prompting data 612 can be generated using the candidate article fitment processing and prompting data generating as described in reference to prompting data 302 and prompting data 602. Prompting data 612, in one example, can specify as follows within variable text based prompting data 614 of prompting data 612: “Zach, the big chair that you selected will not fit in your home office with the large desk you selected. We recommend the following smaller size desk.” In generating the described next prompting data 612, manager system 110 at the prior iteration of assessing block 1111 can have evaluated candidate alternative desk having smaller footprint 926 than footprint 920 and can have determined in the prior iteration of assessing block 1111 that the desk having footprint 926 and the chair having footprint 924 can be accommodated together within open area A of the functional home office space depicted in FIG. 9.

In the described scenario, Zach, the user, can move the prompted for smaller desk having model number K226 into the online shopping cart for replacement of desk K105 so that the shopping cart of FIG. 6 now depicts the selected larger chair C698 and the smaller desk K226. Manager system 110, with the shopping cart configured as described at a next iteration of assessing block 1111 can confirm that desk K226 and chair C698 can be fitted together within open area A of FIG. 9 and can accordingly, at a next iteration of prompting, generate prompting data at block 1115 for sending at block 1116 which specifies in variable text based prompting data area 622 such prompting data as “Zach, Good News! Your selected desk K226 and chair C698 can fit together in your home office.” Such positive reinforcing prompting data defines prompting data that prompts acquisition of an article selected for acquisition.

Accordingly, as set forth herein with reference to FIGS. 1 to 9, manager system 110 can iteratively present prompting data to a user in a manner that is interactive with user selections and which can be dynamically adaptive based on historical behavior and associated functional spaces of a particular user. As noted, manager system 110 can be performing multiple instances of the loop of block 1101-1120 concurrently for multiple different users. Because the prompting data can be adapted based on the user, the prompting data can be adaptively differentiated between different users, and manager system 110 can present differentiated prompting data for first and second users even where the first and second users select a common article for acquisition.

As set forth in the flowchart of FIGS. 2A to 2B, manager system 110 can iteratively update at updating block 1105 spatial data that profiles a functional space associated to a user, which functional space can be iteratively transformed over time by actions of the user including article acquisitions in response to prior presentments of prompting data to the user at prior performed iterations of block 1116. Embodiments herein recognize that such iterative updates of functional space data can impact performance of assessing block 1111 where attributes of a functional space are evaluated. For example, in a first iteration of assessing block 1111 as explained in reference to FIG. 4, manager system 110 can assess a first aggregate open space defined by open areas A. B. and C. However, where the functional space is transformed by inclusion of a described prompted for treadmill, e.g., treadmill model T116 as referenced in the user interface of FIG. 3 which can be qualified and prompted for acquisition with generated prompting data in various scenarios (or a prompted for alternative treadmill such as treadmill model T428 or model T004), manager system 110 can assess a transformed functional space now having a transformed aggregate open space transformed by a new prompted for treadmill having a different set of open areas defining a different aggregate open space. In one aspect, there is set forth herein determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and in dependence on the assessing fitting of the article in the functional space of the user, presenting prompting data to the user, wherein the prompting data prompts for the acquisition of the article, wherein the method includes determining that the user has selected a subsequent article for acquisition, wherein the method includes in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user, and wherein the method includes in dependence on the performing assessing of fitting of subsequent article in the functional space of the user, presenting second prompting data to the user, wherein the assessing fitting the article in the functional space includes evaluating a first aggregate open area of the functional space relative to the article, and wherein the performing assessing of fitting of the subsequent article in the functional space includes evaluation of a second aggregate open area of the functional space with respect to the subsequent article, wherein the second aggregate open area is different from the first aggregate area as a result of dimensional data of the functional space of the user within spaces data of a data repository having been updated by iteratively updating subsequent to the determining that the user has selected the article for acquisition, subsequent to transformation of the functional space by inclusion therein of the article as prompted for by the prompting data, and prior to the determining that the user has selected the subsequent article for acquisition.

In one aspect, there is set forth herein determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and in dependence on the assessing fitting of the article in the functional space of the user, presenting prompting data to the user, wherein the method includes prior to the determining, establishing a data repository having user data on multiple users, spaces data on functional spaces of the multiple users, and articles data on multiple articles, wherein the method includes iteratively updating the user data, spaces data, and the articles data of the data repository, wherein the method includes finding by the assessing fitting that the article is not qualified for fitting in the functional space, and, based on the finding, discovering one or more alternate article for fitting in the functional space, wherein the presenting prompting data includes presenting prompting data that specifies an alternate article, wherein the method includes determining that the user has selected a subsequent article for acquisition, wherein the method includes in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user, and in dependence on the performing assessing of fitting of the subsequent article in the functional space of the user, presenting second prompting data to the user, wherein the assessing fitting the article in the functional space includes evaluating a first aggregate open area of the functional space relative to the article, and wherein the performing assessing of fitting of the subsequent article in the functional space includes evaluation of a second aggregate open area of the functional space with respect to the subsequent article, wherein the second aggregate open area is different from the first aggregate area as a result of dimensional data of the functional space of the user within the spaces data of the data repository having been updated by the iteratively updating subsequent to the determining that the user has selected the article for acquisition, subsequent to transformation of the functional space by inclusion therein of the alternate article as prompted for by the prompting data, and prior to the determining that the user has selected the subsequent article for acquisition.

Referring again to training at training block 1108 and training block 1119, manager system 110 can apply iterations of the described training data for training predictive model 7102 at training block 1108 and/or training block 1119. Embodiments herein recognize that prompting data that is presented to a user can depend on current training of predictive model 7102, and that prompting data presented to a user can adapt over time as training of predictive model 7102 is iteratively updated by training data applied thereto at training block 1108 and/or training block 1119. Embodiments herein recognize, in one aspect, that a prompted for article acquisition can impact a training of predictive model 7102 and accordingly, subsequent predictions output by predictive model 7102 and subsequent prompting data for prompting subsequent article acquisition. In one aspect, there is set forth herein determining that a user has selected an article for acquisition; in response to the determining that the user has selected the article for acquisition, identifying a functional space of the user associated to the article; in response to the identifying the functional space of the user associated to the article, assessing fitting of the article in the functional space of the user; and in dependence on the assessing fitting of the article in the functional space of the user, presenting prompting data to the user, wherein the prompting data prompts for the acquisition of the article, wherein the method includes ascertaining that the user will acquire a complementary article that is complementary to the article, and wherein the assessing fitting includes performing assessment of fitting of the article with the complementary article in the functional space, wherein the ascertaining that the user will acquire a complementary article that is complementary to the article includes querying a machine learning predictive model, wherein the machine learning predictive model has been trained with iterations of training data, wherein the iterations of training data include data of the prior article, acquisitions of the user and additional users, wherein the method includes subsequent to the presenting the prompting data, applying a subsequent iteration of training data to the machine learning predictive model, the subsequent iteration of training data specifying acquisition of the article by the user as prompted for by the prompting data, wherein the method includes determining that the user has selected a subsequent article for acquisition, wherein the method includes responsively to the determining that the user has selected the subsequent article for acquisition, performing subsequent querying of the machine learning predictive model as trained by data for training that includes the training data specifying acquisition of the article by the user as prompted for by the prompting data, and presenting second prompting data to the user in dependence of a result of the performing the subsequent querying of the machine learning predictive model.

Various available tools, libraries, and/or services can be utilized for implementation of predictive model 7102. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring, and retraining deployed models. According to one possible implementation, a machine learning service can provide access to libraries. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Predictive model 7102 can employ various machine learning technologies, e.g., support vector machines (SVM), Bayesian networks, neural networks and/or other machine learning technologies.

Embodiments herein recognize that when articles are acquired by a user they are not optimized in view of factors associated to the user such as a functional space associated to a user and other articles that may be acquired by the user. In one example, an online user may acquire a printer that is not optimally compatible with the specifications of their printer cabinet due to their inability to effectively filter or sort based on optimal compatibility. Embodiments herein provide methods to filter article selections in the context of an existing functional space or additional article. Embodiments herein recognize that when acquiring hardware for unique data centers, it takes a thorough, lengthy process to determine if the equipment and total solution can fit in an optimized data center space.

Embodiments herein can provide a system and method to organize and prioritize articles based on specification compatibility. Embodiments herein can digest locational specifications and complementary good information to provide a filtered list of article compatibility.

According to one example: Zach has 10 devices using Thunderbolt chargers, so the flashlight with a rechargeable thunderbolt input is the highest priority.

According to one example: Zach's room with similar fitness devices has a clearance of 3 feet by 4 feet, the 3×3 device is prioritized over the 3×5 device. Embodiments herein can contextualize articles as supplementary to replace an existing article and does not count that space. In one example, embodiments herein can identify possible article movement opportunities in a space based on room categorization.

According to one example: Lynnessa is looking to purchase a new kitchen espresso machine for her kitchen online. She is unsure of how the dimensions of the new coffee large espresso machine will fit into her kitchen, and does not want to purchase something that does not fit within her unique kitchen. She also has limited counter space. She uses the e-commerce article or specification compatibility filtering application to filter her article options based on the specifications of her kitchen. She can authorize input of the dimensions of her kitchen counter spaces and manager system 110 will then filter out article options that do not fit in her kitchen. She is happy that she never bought the medium and larger sizes, as she only had room for the smaller unit.

According to one example: Enterprise systems featuring article providing services can use the e-commerce article or specification compatibility filtering application to help users find the right articles for their specific needs. Most importantly, it will allow for the user to use the application, then can filter articles based on the user's specifications (or lack thereof) and needs, such as size, color, that is specific to their own unique environment, thus, to help them find a suitable article for their home or office or operations facility.

Embodiments herein can include a recommendation engine that would prioritize articles by suggesting complementary article options (after the list has been filtered by the original intent). For example, the recommendation engine could suggest a printer cabinet that is compatible with the specifications of a printer being purchased, but that fits that specific printer perfectly with the user's existing desk set.

Embodiments herein can include a customer service feedback feature that would allow users to provide feedback on the compatibility of the article with their designated space (for people with “like” limited spaces, physical constraints, etc.).

Embodiments herein can include: (1) A user can opt in to manager system 110 by providing manager system 110 access to e-commerce history and spatial map of destination. This may include, e.g., article acquisition history, blueprints, digital twin of the space, or other metadata such as a video feed; (2) The user enters a selection to interact with manager system 110 which can provide, e.g., compatibility detection, similarity detection, and frequency detection; (3) Manager system 110 integrates and retrieves the user's history and spatial map, e.g., through a stored customer profile or integration with other devices; (4) Manager system 110 executes a spatial estimation based on physical size and article ontology. This step may take an article and put it into a relevant category or room based on its categorization using an AI module or manual user input. This step may validate or allow the user to input information such as supplementary article or replacement article to capture spatial usage. Manager system 110 can retrieve 3D blueprints or blueprint specifications as derived via image, video feeds, or blueprint integration. Manager system 110 can take the blueprints and identify locational opportunities in the designated room and free space computations. This processing may be augmented by requesting user actions such as additional measuring or image/video feeding; (5) The commercial list of options can be filtered based on these details along with providing information surrounding the placement of the packed and unpacked article; (6) Manager system 110 can identify complementary articles based on comments, specifications, associated similar acquired articles or other information. Complementary articles can act as a weighting if there are multiple other owned or possessed articles that may be similar or share devices or subcomponents such as plugs, chargers, input types, etc.; (7) Manager system 110 can present the user a final filtered view of articles based on the specifications of the physical placement and complementary goods owned. Inputs can include, e.g., user history, spatial map of source/destination (digital or physical), 3D blueprints, or article ontology. Outputs can include spatial estimation, categorization of articles, complementary articles, final filtered view, and/or knowledge corpus updates.

Certain embodiments herein may offer various technical computing advantages involving computing advantages to address problems arising in the realm of computer systems. Embodiments herein can include a user interactive user interface that responds to selections of a user in which can adaptively present prompting data that is adaptive not only to selections of the user, but also to historical behavior of a particular user. Embodiments herein can include dynamically and adaptively updating a user interface in dependence on a user selection of an article so that if a selected article is not qualified for fitting within a functional space associated to a user, the user can be prompted with prompting data to select an alternative article. Embodiments herein can include predictions as to additional complementary articles that can be acquired in addition to a selected article and fitment analysis performed herein can be extended to include and encompass such additional articles predicted for acquisition. Embodiments herein can include iteratively updating user profile space profiles and article profiles based on updated return data updated based on iteratively applied query data. By the innovative updating of user profile space profiles and article profiles prompting data that is generated for a particular user based on selection of a certain article can evolve over time as behavior patterns of the user and other users and attributes of spaces and articles evolve over time. Embodiments herein can adapt prompting data presented on the user interface to a user in dependence on sensed real-world conditions sensed in respect to an actual functional space associated to the user, e.g., a home residence functional space of the user having a profile that is iteratively updated. Embodiments herein can employ predictive models that are trained by machine learning, such as a predictive model that predicts a complementary article that can be acquired by user with a selected article for acquisition. In space fitments and associated resulting prompting data associated to such space fitments can be extended to include assessments in regard to not only a selected article, but a predicted one or more article complementary with the selected article that is predicted to also be acquired by a user. In dependence on a selection by a user assessed to raise a fitment conflict, a user may be presented with prompting data that prompts the user to make an alternative selection with respect to one or more article. In further aspects, adaptively provided prompting data provided to a user prompts for transformation of a functional space associated to a user, and the transformation adapts subsequent prompting data to a user. The dynamic user interface accordingly can dynamically adapt based on a multitude of factors including user selections, historical behavior of a current user, historical behavior of crowdsourced other users, changes in a functional space as detected by one or more IoT device and as prompted for by presented prompting data, and changes in determined attributes with respect to articles for acquisition. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

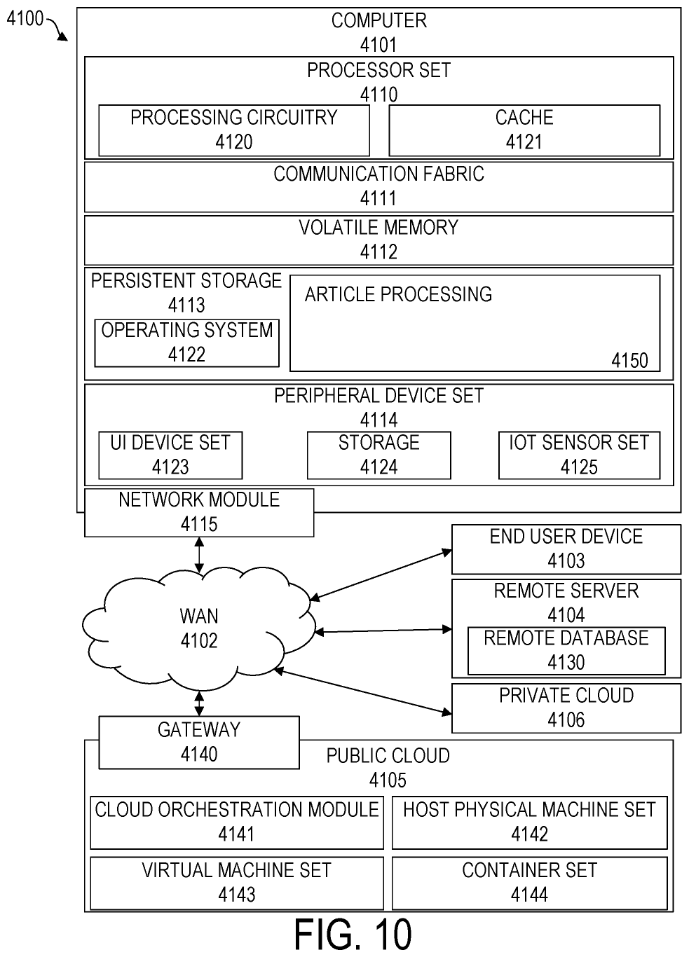

In reference to FIG. 10, there is set forth a description of a computing environment 4100 that can include one or more computer 4101. In one example, computing node 10 as set forth herein can be provided in accordance with computer 4101 as set forth in FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 10. In one aspect, a computing environment 4100 contains an example of an environment for the execution of at least some of the computer code involved in performing the inventive methods, such as code 4150 for performing article processing described with reference to FIGS. 1 to 9. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments. UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure. Examples herein are prophetic examples selected for illustrating functional aspects of embodiments herein.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
determining that a user has selected an article for acquisition;
in response to the determining that the user has selected the article for acquisition, identifying a functional space of the user associated to the article;
in response to the identifying the functional space of the user associated to the article, assessing fitting of the article in the functional space of the user; and
interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

2. The computer implemented method of claim 1, wherein method includes finding by the assessing fitting that the article is not qualified for fitting in the functional space, and, based on the finding, discovering one or more alternate article for fitting in the functional space.

3. The computer implemented method of claim 1, wherein method includes finding by the assessing fitting that the article is qualified for fitting in the functional space, and wherein the presenting prompting data includes presenting prompting data that specifies to the user that the article is qualified for fitting in the functional space.

4. The computer implemented method of claim 1, wherein the method includes ascertaining that the user will acquire a complementary article that is complementary to the article, and wherein the assessing fitting includes performing assessment of fitting of the article with the complementary article in the functional space.

5. The computer implemented method of claim 1, wherein method includes finding by the assessing fitting that the article is not qualified for fitting in the functional space, and, based on the finding, discovering one or more alternate article for fitting in the functional space, wherein the presenting prompting data includes presenting prompting data that specifies the one or more alternate article.

6. The computer implemented method of claim 1, wherein the assessing fitting includes disqualifying the article on the determining that the inclusion of the article in the functional space will leave a threshold satisfying amount of additional area in the functional space.

7. The computer implemented method of claim 1, wherein the assessing fitting includes disqualifying the article on the determining that the article is too large to be fitted in the functional space.

8. The computer implemented method of claim 1, wherein the method includes performing natural language processing of crowdsourced text based content associated to the article, identifying based on the natural language processing that the article is operationally larger than a recorded dimension of the article, and increasing the recorded size of the article for use in performing the assessing fitting responsively to the identifying based on the natural language processing that the article is operationally larger than a recorded dimension of the article.

9. The computer implemented method of claim 1, wherein the method includes prior to the determining, establishing a data repository having user data on multiple users, spaces data on functional spaces of the multiple users, and articles data on multiple articles, wherein the method includes iteratively updating the user data, spaces data, and the articles data of the data repository, wherein the assessing fitting includes calling dimensional data of the functional space and the article from the data repository.

10. The computer implemented method of claim 1, wherein the method includes determining that the user has selected a subsequent article for acquisition, in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user; and wherein the method includes in dependence on the performing assessing of fitting of subsequent article in the functional space of the user, presenting second prompting data to the user, wherein the assessing fitting the article in the functional space includes evaluating a first aggregate open space of the functional space relative to article, and wherein the performing assessing of fitting of the subsequent article in the functional space includes evaluation a second aggregate open space of the functional space with respect to the subsequent article.

11. The computer implemented method of claim 1, wherein the method includes prior to the determining, establishing a data repository having user data on multiple users, spaces data on functional spaces of the multiple users, and articles data on multiple articles, wherein the method includes iteratively updating the user data, spaces data, and the articles data of the data repository, wherein method includes finding by the assessing fitting that the article is not qualified for fitting in the functional space, and, based on the finding, discovering one or more alternate article for fitting in the functional space, wherein the presenting prompting data includes presenting prompting data that specifies an alternate article, wherein the method includes determining that the user has selected a subsequent article for acquisition, wherein the method includes in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user, and in dependence on the performing assessing of fitting of subsequent article in the functional space of the user, presenting second prompting data to the user, wherein the assessing fitting the article in the functional space includes evaluating a first aggregate open area of the functional space relative to article, and wherein the performing assessing of fitting of the subsequent article in the functional space includes evaluation a second aggregate open area of the functional space with respect to the subsequent article, wherein the second aggregate open area is different from the first aggregate area as a result of dimensional data of the functional space of the user within the spaces data of the data repository having been updated by the iteratively updating subsequent to the determining that the user has selected the article for acquisition, subsequent to transformation of the functional space by inclusion therein of the alternate article as prompted for by the prompting data, and prior to the determining that the user has selected the subsequent article for acquisition.

12. The computer implemented method of claim 1, wherein the method includes ascertaining that the user will acquire a complementary article that is complementary to the article, and wherein the assessing fitting includes performing assessment of fitting of the article with the complementary article in the functional space, wherein the ascertaining that the user will acquire a complementary article that is complementary to the article includes querying a machine learning predictive model, wherein the machine learning predictive model has been trained with iterations of training data, wherein the iterations of training data include data of prior article acquisitions of the user and additional users.

13. The computer implemented method of claim 1, wherein the prompting data prompts for the acquisition of the article, wherein the method includes ascertaining that the user will acquire a complementary article that is complementary to the article, and wherein the assessing fitting includes performing assessment of fitting of the article with the complementary article in the functional space, wherein the ascertaining that the user will acquire a complementary article that is complementary to the article includes querying a machine learning predictive model, wherein the machine learning predictive model has been trained with iterations of training data, wherein the iterations of training data include data of prior article acquisitions of the user and additional users, wherein the method includes subsequent to the presenting the prompting data, applying a subsequent iteration of training data to the machine learning predictive model, the subsequent iteration of training data specifying acquisition of the article by the user as prompted for by the prompting data, wherein the method includes determining that the user has selected a subsequent article for acquisition, wherein the method includes responsively to the determining that the user has selected the subsequent article for acquisition, performing subsequent querying of the machine learning predictive model as trained by data for training that includes the training data specifying acquisition of the article by the user as prompted for by the prompting data, and presenting second prompting data to the user in dependence of a result of the performing the subsequent querying of the machine learning predictive model.

14. The computer implemented method of claim 1, wherein the method includes finding by the assessing fitting that the article is not qualified for fitting in the functional space, and, based on the finding, discovering one or more alternate article for fitting in the functional space, wherein the discovering includes looking up dimensional data of multiple candidate articles having a common article classification from a data repository, assessing candidate article fitting of the multiple candidate articles within the functional space, and filtering out a subset of the multiple candidate articles based on finding from the assessing candidate article fitting that the subset of the multiple candidate articles are not qualified for fitting within the functional space.

15. The computer implemented method of claim 1, wherein the prompting data prompts for the acquisition of the article, wherein the method includes prior to the determining that the user has selected an article for acquisition, establishing a data repository having user data on multiple users, spaces data on functional spaces of the multiple users, and articles data on multiple articles, wherein the method includes iteratively updating the user data, spaces data, and the articles data of the data repository, wherein the method includes determining that the user has selected a subsequent article for acquisition, wherein the method includes in response to the determining that the user has selected the subsequent article for acquisition identifying the functional space of the user associated to the subsequent article, wherein the method includes in response to the identifying the functional space of the user associated to the subsequent article, performing assessment fitting of the subsequent article in the functional space of the user, and wherein the method includes in dependence on the performing assessing of fitting of the subsequent article in the functional space of the user, presenting second prompting data to the user, wherein the assessing fitting the article in the functional space includes evaluating a first aggregate open space of the functional space relative to article, and wherein the performing assessing of fitting of the subsequent article in the functional space includes evaluation a second aggregate open space of the functional space with respect to the subsequent article, wherein the second aggregate open space is different from the first aggregate open space as a result of dimensional data of the functional space of the user within the spaces data of the data repository having been updated by the iteratively updating subsequent to the determining that the user has selected the article for acquisition, subsequent to transformation of the functional space by inclusion therein of the article as prompted for by the prompting data, and prior to the determining that the user has selected the subsequent article for acquisition, wherein the method includes responsively to the determining that the user has selected the article for acquisition ascertaining that the user will acquire a complementary article that is complementary to the article, and wherein the assessing fitting includes performing assessment of fitting of the article with the complementary article in the functional space, wherein the ascertaining that the user will acquire a complementary article that is complementary to the article includes querying a machine learning predictive model, wherein the machine learning predictive model has been trained with iterations of training data, wherein the iterations of training data include data of prior article acquisitions of the user and additional users, wherein the method includes subsequent to the presenting the prompting data, applying a subsequent iteration of training data to the machine learning predictive model, the subsequent iteration of training data specifying acquisition of the article by the user as prompted for by the prompting data, wherein the method includes responsively to the determining that the user has selected the subsequent article for acquisition, performing subsequent querying of the machine learning predictive model which at a time of the subsequent querying has been trained by data for training that includes the training data specifying acquisition of the article by the user as prompted for by the prompting data, wherein the presenting the second prompting data to the user is performed in dependence of a result of the subsequent querying.

16. The computer implemented method of claim 1, wherein the prompting data prompts for the acquisition of the article, wherein the method includes determining that the user has selected a subsequent article for acquisition, wherein the method includes in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user, and wherein the method includes in dependence on the performing assessing of fitting of subsequent article in the functional space of the user, presenting second prompting data to the user, wherein the assessing fitting the article in the functional space includes evaluating a first aggregate open area of the functional space relative to article, and wherein the performing assessing of fitting of the subsequent article in the functional space includes evaluation of a second aggregate open area of the functional space with respect to the subsequent article, wherein the second aggregate open area is different from the first aggregate area as a result of dimensional data of the functional space of the user within spaces data of a data repository having been updated by iteratively updating subsequent to the determining that the user has selected the article for acquisition, subsequent to transformation of the functional space by inclusion therein of the article as prompted for by the prompting data, and prior to the determining that the user has selected the subsequent article for acquisition.

17. A computer program product comprising:
a computer readable storage medium readable by one or more processing circuit and storing instructions for execution by one or more processor for performing a method comprising:
determining that a user has selected an article for acquisition;
in response to the determining that the user has selected the article for acquisition, identifying a functional space of the user associated to the article;
in response to the identifying the functional space of the user associated to the article, assessing fitting of the article in the functional space of the user; and
interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

18. A system comprising:
a memory;
at least one processor in communication with the memory; and
program instructions executable by one or more processor via the memory to perform a method comprising:
determining that a user has selected an article for acquisition;
in response to the determining that the user has selected the article for acquisition, identifying a functional space of the user associated to the article;
in response to the identifying the functional space of the user associated to the article, assessing fitting of the article in the functional space of the user; and
interacting with the user in dependence on the assessing fitting of the article in the functional space of the user, wherein the interacting with the user includes adaptively generating user interface prompting data in dependence on the assessing fitting of the article in the functional space of the user, and presenting the adaptively generated user interface prompting data to the user.

19. The system of claim 18, wherein the method includes finding by the assessing fitting that the article is not qualified for fitting in the functional space, and, based on the finding, discovering one or more alternate article for fitting in the functional space, wherein the discovering includes looking up dimensional data of multiple candidate articles having a common article classification from a data repository, assessing candidate article fitting of the multiple candidate articles within the functional space, and filtering out a subset of the multiple candidate articles based on finding from the assessing candidate article fitting that the subset of the multiple candidate articles are not qualified for fitting within the functional space.

20. The system of claim 18, wherein the prompting data prompts for acquisition of the article, wherein the method includes determining that the user has selected a subsequent article for acquisition, in response to the determining that the user has selected the subsequent article for acquisition, identifying the functional space of the user associated to the subsequent article, wherein the method includes in response to the identifying the functional space of the user associated to the subsequent article, performing assessment fitting of the subsequent article in the functional space of the user, and wherein the method includes in dependence on the performing assessing of fitting of subsequent article in the functional space of the user, presenting second prompting data to the user, wherein the assessing fitting the article in the functional space includes evaluating a first aggregate open space of the functional space relative to article, and wherein the performing assessing of fitting of the subsequent article in the functional space includes evaluation a second aggregate open space of the functional space with respect to the subsequent article, the second aggregate open space being different from the first aggregate open space as a result of the functional space being transformed by inclusion of the article as prompted for by the prompting data.
